(19) United States
(12) Patent Application Publication
(10) Pub. No.: US 2026/0074442 A1
(43) Pub. Date: Mar. 12, 2026

(54) LOW-PROFILE CONNECTOR

(71) Applicant: KYOCERA AVX Components Corporation, Fountain Inn, SC (US)

(72) Inventor: Brent Lybrand, Fountain Inn, SC (US)

(21) Appl. No.: 19/270,792

(22) Filed: Jul. 16, 2025

Related U.S. Application Data
(60) Provisional application No. 63/693,987, filed on Sep. 12, 2024.

(51) Int. Cl. H01R 4/2452; H01R 12/53; H01R 43/01

(52) U.S. Cl. CPC H01R 4/2452; H01R 12/53; H01R 43/01

(57) ABSTRACT

A wire connector includes a base portion, a first portion extending from a first side of the base portion, and a second portion extending from a second side of the base portion, the second side being opposite the first side. Each of the first portion and the second portion are bent relative to the base portion toward a central axis of the connector. Each of the first portion and the second portion includes a first contact member and a second contact member, each of the first contact member and second contact member being structured to bend toward the central axis of the connector.

### CROSS-REFERENCE TO RELATED APPLICATION

This application claims priority to U.S. Provisional Patent Application No. 63/693,987, filed September 12, 2024, the entire disclosure of which is incorporated herein by reference in its entirety, for any and all purposes.

### FIELD

The present disclosure relates generally to the field electrical connectors, and more particularly to a type of connector used to connect an electrical wire to an electrical component.

### BACKGROUND

The following description is provided to assist the understanding of the reader. None of the information provided or references cited is admitted to be prior art.

Many connector types can be used to form connections between an insulated wire and any manner of electronic or electrical component. These connectors can be available as sockets, plugs, and shrouded headers in a variety of sizes, pitches, and plating options. Although necessary for forming electrical connections, some connectors can have substantial footprints to accommodate receiving wires—particularly when wires must extend in opposing directions. Depending on the type of connector required, coupling or otherwise integrating the connector to the electronic or electrical component can result in a connection having a significant footprint.

Accordingly, it would be advantageous to provide a connector having a minimal footprint that can facilitate wire-to-wire connections, including when coupled to an electronic or electrical component.

### SUMMARY

At least one aspect of the present disclosure relates to a wire connector. The wire connector includes a base portion, a first portion extending from a first side of the base portion, and a second portion extending from a second side of the base portion, the second side being opposite the first side. Each of the first portion and the second portion are bent relative to the base portion toward a central axis of the connector. Each of the first portion and the second portion includes a first contact member and a second contact member, each of the first contact member and second contact member structured to bend toward the central axis of the connector.

In various embodiments, the first contact member and the second contact member are structured to bend at an angle of approximately 90 degrees. In some embodiments, the first portion forms a first slot and the second portion forms a second slot, the second slot being aligned with the first slot. In other embodiments, at least one interior edge of each of the first slot and the second slot is sharpened. In yet other embodiments, a length of the first slot and the second slot is equivalent to a distance between a top edge of the wire connector and a bottom edge of each of the first contact member and second contact member. In various embodiments, each of the first portion and the second portion further includes a first arch and a second arch, where the first slot is formed between the first arch and second arch of the first portion, and the second slot is formed between the first arch and second arch of the second portion. In some embodiments, the first contact member and second contact member are formed at the terminal ends of the first arch and the second arch, respectively. In other embodiments, wherein each of the first contact member and the second contact member comprises a contact pad at a terminal end thereof, wherein the contact pad is disposed at a distance above the base portion.

Another aspect of the present disclosure relates to a wire connector assembly. The assembly includes an electrical component having a first height. The electrical component incudes a first conductive region, a second conductive region, and an aperture disposed between the first conductive region and the second conductive region. The assembly also includes a wire connector having a second height and being structured to couple to the electrical component. The wire connector includes a base portion, a first portion extending from a first side of the base portion, and a second portion extending from a second, opposite side of the base portion, where the base portion of the wire connector is structured to be received within the aperture of the electrical component such that a third height of the wire connector assembly is less than a sum of the first height and the second height.

In various embodiments, each of the first portion and the second portion includes a first arch, a second arch, and a slot formed between the first arch and the second arch. In some embodiments, the assembly also includes a wire, wherein the wire is configured to be received within the slot of each of the first portion and the second portion. In other embodiments, at least one interior edge of the slot is sharpened such that when the wire is received within the slot of each of the first portion and the second portion, the at least one interior edge of the slot cuts through insulation surrounding the wire. In yet other embodiments, where the first arch terminates in a first contact member and the second arch terminates in a second contact member, the first contact member being structured to bend away from the first arch and the second contact member structured to bend away from the second arch. In various embodiments, the first contact member and second contact member are structured to bend toward a central axis of the wire connector. In some embodiments, the first contact member and second contact member are structured to bend away from a central axis of the wire connector. In other embodiments, the first contact member of the first portion and the first contact member of the second portion are structured to couple to the first conductive region, and the second contact member of the first portion and the second contact member of the second portion are structured to couple to the second conductive region. In yet other embodiments, the electrical component is a printed circuit board.

Yet another aspect of the present disclosure relate to a method of forming a wire connector assembly. The method includes forming a wire connector, coupling the wire connector to an electrical component, and connecting a wire to the wire connector. The wire connector includes a base portion, a first portion extending from a first side of the base portion, and a second portion extending from a second, opposite side of the base portion. The electrical component includes an aperture, a first conductive region disposed on a first side of the aperture, and a second conductive region disposed on a second side of the aperture. Coupling the wire connector to the electrical component includes inserting the base portion into the aperture, coupling a first region of each of the first portion and the second portion to first conductive region, and coupling a second region of each of the first portion and the second portion to the second conductive region.

In various implementations, coupling the first region of each of the first portion and the second portion to the first conductive region includes soldering the first region of each of the first portion and the second portion to the first conductive region, and coupling the second region of each of the first portion and the second portion to the second conductive region includes soldering the second region of each of the first portion and the second portion to the second conductive region. In some implementations, forming the wire connector includes forming a sheet material segment, forming each of the first portion and the second portion by bending the first portion and the second portion relative to a central axis of the sheet material segment, and separating the wire connector from the sheet material segment by separating the base portion at a first side and a second side.

### BRIEF DESCRIPTION OF THE DRAWINGS

The disclosure will become more fully understood from the following detailed description, taken in conjunction with the accompanying figures, wherein like reference numerals refer to like elements, in which:

FIG. 1 is a perspective view of a wire connector system, according to at least one embodiment.

FIG. 2 is an alternate perspective view of the wire connector system of FIG. 1, according to at least one embodiment.

FIG. 3 is a perspective view of a wire connector within the wire connector system of FIG. 1, according to at least one embodiment.

FIG. 4 is a perspective view of an electrical component within the wire connector system of FIG. 1, according to at least one embodiment.

FIG. 5A is a perspective view of the wire connector system of FIG. 1 in a disassembled state, according to at least one embodiment.

FIG. 5B is a perspective view of the wire connector system of FIG. 1 in a partially disassembled state, according to at least one embodiment.

FIG. 5C is a perspective view of the wire connector system of FIG. 1 in an assembled state, according to at least one embodiment.

FIG. 6 is a perspective view of a wire connector system, according to at least one embodiment.

FIG. 7 is a perspective view of a wire connector within the wire connector system of FIG. 1, according to at least one embodiment.

FIG. 8 is a perspective view of a wire connector system, according to at least one embodiment.

FIG. 9 is a top perspective view of a sheet for forming a wire connector, according to at least one embodiment.

### DETAILED DESCRIPTION

Before turning to the figures, which illustrate certain exemplary embodiments in detail, it should be understood that the present disclosure is not limited to the details or methodology set forth in the description or illustrated in the figures. It should also be understood that the terminology used herein is for the purpose of description only and should not be regarded as limiting.

Referring generally to the figures, a low-profile wire connection system includes a connector, which is structured to receive a wire. The connector can include a base portion that includes a first contact portion and a second contact portion extending opposite the first contact portion. Each of the first and second contact portions includes a first and second contact member structured to contact one or more solder pads on an electrical component.

In various embodiments, the connector is configured for connecting a conductive core of a wire with an electrical component, such as a printed circuit board (PCB). The connector is configured such that the base portion is received within a recess of the electrical component such that a height of the resulting wire connector system (including the connector and electrical component) is less than a sum of the heights of each of the connector and the electrical component.

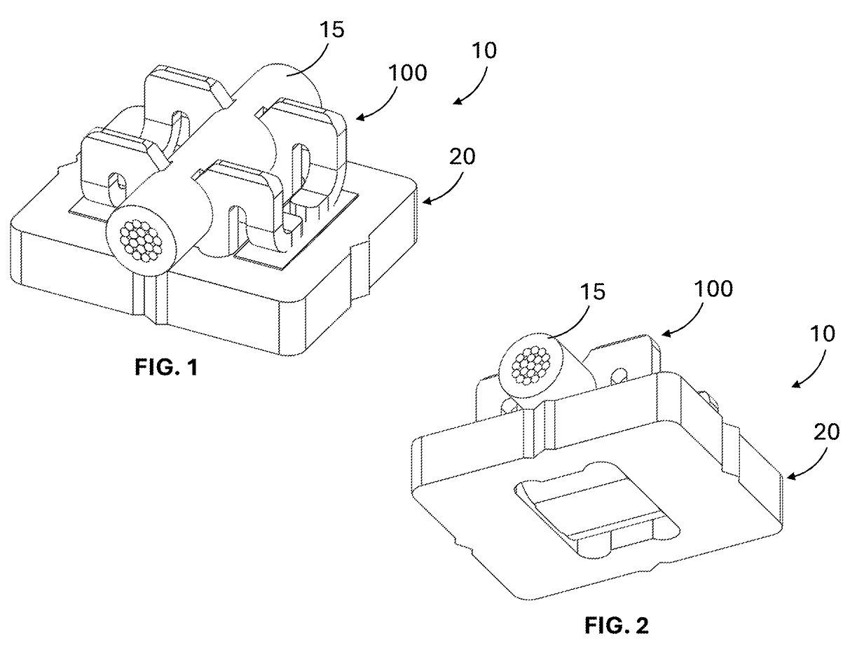

Turning now to the figures and referring specifically to FIGS. 1 and 2, a wire connector system 10 is shown. The wire connector system 10 includes a connector 100, which is structured to receive a wire 15. The wire 15 can be an insulated wire. The wire connector system 10 also includes an electrical component 20, which is configured to electrically couple to the connector 100. In various embodiments, the electrical component 20 is a PCB. In some embodiments, the electrical component 20 is disposed or integrated within an electrical device.

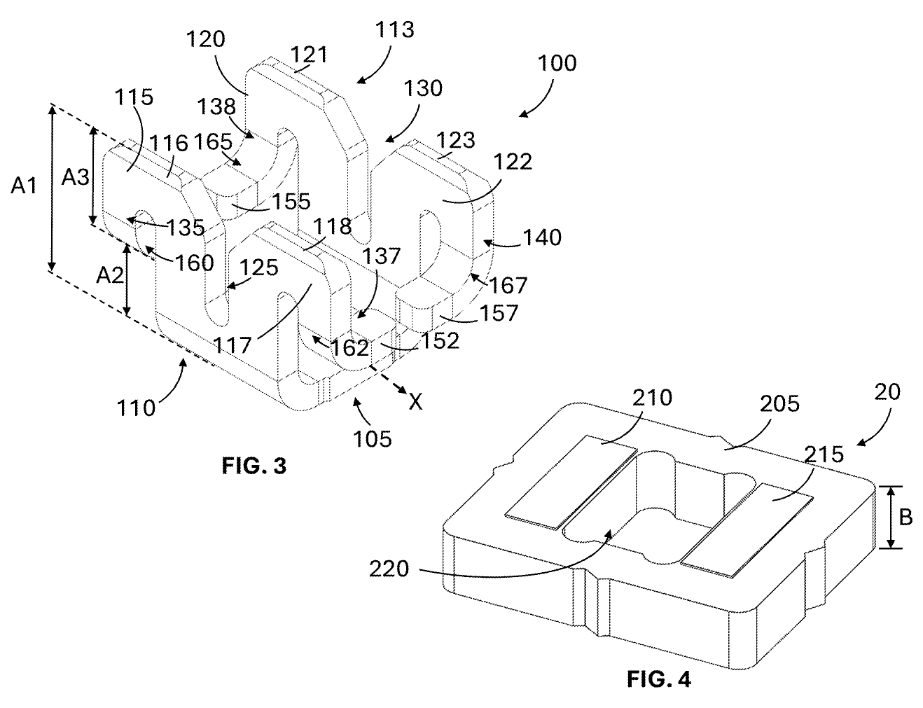

FIG. 3 shows a perspective view of the connector 100, according to at least one embodiment. In various embodiments, the connector 100 is structured as an insulation displacement connector (IDC) 100. The connector 100 includes a base portion 105 and two contact portions extending therefrom. As shown in FIG. 3, a first contact portion 110 extends from a first side of the base portion 105 and a second contact portion 113 extends from a second, opposite side of the base portion 105. In various embodiments, such as shown in FIG. 3, each of the first contact portion 110 and the second contact portion 113 is oriented in a direction that is substantially perpendicular to a plane defined by the base portion 105. For example, as shown, each of the first contact portion 110 and the second contact portion 113 extend vertically upward, away from the base 105.

The first contact portion 110 is structured to include a first arm 115 and a second arm 117. Each of the first arm 115 and the second arm 117 are formed to have an arched or u-shape. As shown, the first arm 115 forms an arch 116 and the second arm 117 forms an arch 118, where an apex of each of the arch 116 and the arch 118 define an uppermost portion of the first contact portion 110 relative to the base portion 105 (i.e., having a greatest perpendicular distance from the base portion 105).

As shown, the first arm 115 includes a first contact member 135, which extends from the arch 116 and forms a terminal end of the first arm 115. Similarly, the second arm 117 includes a second contact member 137, which extends from the arch 118 and forms a terminal end of the second arm 117. As shown, the first contact member 135 can be structured to bend away from the arch 116 at an elbow 160 to form a first contact pad 150. The first contact pad 150 can be a substantially flat region at the terminal end of the contact member 135 that can be connectible to one or more electrical components. Similarly, the second contact member 137 can be structured to bend away from the arch 118 at an elbow 162 to form a second contact pad 152. The second contact pad 152 can be a substantially flat region at the terminal end of the contact member 137 that can be connectible to one or more electrical components. In various embodiments, each of the first contact member 135 and the second contact member 137 can be structured to bend away from the respective arch 116 and arch 118 in a direction toward the base portion 105 (i.e., such that the first contact pad 150 and the second contact pad 152 are oriented toward the second portion 113). In various embodiments, each of the first contact member 135 and the second contact member 137 can be structured to bend away from the respective arch 116 and the arch 118 in a direction away the base portion 105 (i.e., such that the first contact pad 150 and the second contact pad 152 are oriented away from the base portion 105). In some embodiments, each of the first contact member 135 and the second contact member 137 can be structured to bend away from the respective arch 116 and the arch 118 at approximately a 90 degree angle. For example, as shown in FIG. 3, each of the elbows 160, 162 can be structured to bend at approximately a 90 degree angle such that the respective contact pads 150, 152 are substantially parallel to the base portion 105.

Similar to the first contact portion 110, the second contact portion 113 is structured to include a first arm 120 and a second arm 122. Each of the first arm 120 and the second arm 122 are formed to have an arched or u-shape. As shown, the first arm 120 forms an arch 121 and the second arm 122 forms an arch 123, where an apex of each of the arch 121 and the arch 123 define an uppermost portion of the first contact portion 113 relative to the base portion 105 (i.e., having a greatest perpendicular distance from the base portion 105).

As shown, the first arm 120 includes a first contact member 138, which extends from the arch 121 and forms a terminal end of the first arm 120. Similarly, the second arm 122 includes a second contact member 140, which extends from the arch 123 and forms a terminal end of the second arm 122. As shown, the first contact member 138 can be structured to bend away from the arch 121 at an elbow 165 to form a first contact pad 155. The first contact pad 155 can be a substantially flat region at the terminal end of the contact member 138 that can be connectible to one or more electrical components. Similarly, the second contact member 140 can be structured to bend away from the arch 123 at an elbow 167 to form a second contact pad 157. The second contact pad 157 can be a substantially flat region at the terminal end of the contact member 140 that can be connectible to one or more electrical components. In various embodiments, each of the first contact member 138 and the second contact member 140 can be structured to bend away from the respective arch 121 and the arch 123 in a direction toward the base portion 105 (i.e., such that the first contact pad 155 and the second contact pad 157 are oriented toward the first portion 110). In various embodiments, each of the first contact member 138 and the second contact member 140 can be structured to bend away from the respective arch 121 and the arch 123 in a direction away from the base portion 105 (i.e., such that the first contact pad 155 and the second contact pad 157 are oriented away from the base portion 105). In some embodiments, each of the first contact member 138 and the second contact member 140 can be structured to bend away from the respective arch 121 and the arch 123 at approximately a 90 degree angle. For example, as shown in FIG. 3, each of the elbows 165, 167 can be structured to bend at approximately a 90 degree angle such that the respective contact pads 155, 157 are substantially parallel to the base portion 105.

As shown in FIG. 3, each of the first portion 110 and the second portion 113 can be structured in a mirrored arrangement relative to the base portion 105. Each of the first portion 110 and the second portion 113 can be substantially parallel such that the connector 100 has a height A1, which can be defined as a perpendicular distance between the base portion 105 and a topmost point of the first portion 110 and/or the second portion 113. As shown in FIG. 3, each of the arms of the first portion 110 and second portion 113 are structured such that each contact member bends from its corresponding contact pad at a height A2, defined as a perpendicular distance from the base portion 105 to the contact pad, and a distance A3, defined as a perpendicular distance from a top edge of the connector 100 (i.e., a top edge of the respective first portion 110 or second contact portion 113) to the contact pad. Accordingly, each of the first contact pad 150 and the second contact pad 152 are disposed at a height A2 relative to the base portion 105, and a distance A3 from a top edge of the first portion 110. Similarly, each of the first contact pad 155 and the second contact pad 157 are disposed at the height A2 relative to the base portion 105 and a distance A3 from a top edge of the second portion 113.

As described above, the connector 100 can be an IDC such that it can receive and form an electrical connection with an insulated wire (e.g., the wire 15). Accordingly, as shown in FIG. 3, each of the first portion 110 and the second portion 113 include a respective first slot 125 and second slot 130, which are axially parallel and configured to receive the wire 15 therein. The first slot 125 can be formed between the first arm 115 and the second arm 117. Similarly, the second slot can be formed between the first arm 120 and the second arm 122. Each of the first slot 125 and the second slot 130 can be IDC slots. For example, in various embodiments, each of the first slot 125 and the second slot 130 can be formed such that at least one inner edge is sharpened to facilitate cutting through insulation on the wire 15 and enable an electrical connection therewith. In various embodiments, the first slot 125 and the second slot 130 can have a uniform width. In some embodiments, a width of each of the first slot 125 and the second slot 130 is less than a width of the wire 15 to facilitate an IDC connection. In other embodiments, the first slot 125 and the second slot 130 can be tapered such that a width of each slot decreases with proximity to the base portion. In various embodiments, a length of each of the first slot 125 and the second slot 130 is approximately the same as the distance A3. In other embodiments, the length of the first slot 125 and the second slot 130 may be varied relative to the distance A3 to accommodate differing design requirements.

Turning now to FIG. 4, the electrical component 20 is shown, in accordance with at least one embodiment. In various embodiments, the electrical component 20 is a PCB. In other embodiments, the electrical component 20 is any electrically connectible portion of an electrical device or system. The electrical component 20 can include a body 205 having a thickness or height B. The body 205 can be made of a non-conductive material that is structured to include (e.g., via etching, printing, etc.) a plurality of embedded electrically conductive surfaces.

The body 205 can be structured to include at least one recess or aperture 220, which can extend partially or entirely through a thickness of the body 205. The electrical component 20 can include at least one first conductive pad 210 and at least one second conductive pad 215, where each of the conductive pads are disposed adjacent to the aperture 220. In various embodiments, each of the first conductive pad 210 and the second conductive pad 215 are solder pads. In some embodiments, each of the first conductive pad 210 and the second conductive pad 215 can include or be made up of a plurality of conductive portions. As shown in FIG. 3, first conductive pad 210 can be disposed on a first side of the aperture 220 and the second conductive pad 215 can be disposed on a second, opposite side of the aperture 220. In various embodiments, the aperture 220 can be substantially rectangular in shape. In various embodiments, each of the first conductive pad 210 and the second conductive pad 215 have a length that corresponds to a length of a side of the aperture 220. In various embodiments, the aperture 220 is sized and shaped to correspond to a shape of the base portion 105 of the connector 100.

It should be noted that although FIG. 4 shows the electrical component 20 being substantially rectangular in shape, the electrical component 20 can have any suitable shape known in the art. Furthermore, although FIG. 4 show the electrical component 20 including a single aperture 220 disposed between the first conductive pad 210 and the second conductive pad 215, in various embodiments, the electrical component 20 can include any number of apertures 220 and conductive pads. For example, in some embodiments, the electrical component 20 can include a plurality of apertures 220, each spaced from an adjacent aperture, where each aperture of the plurality of apertures 220 is disposed between a first conductive pad (i.e., similar or equivalent to the first conductive pad 210) and a second conductive pad (i.e., similar or equivalent to the second conductive pad 215).

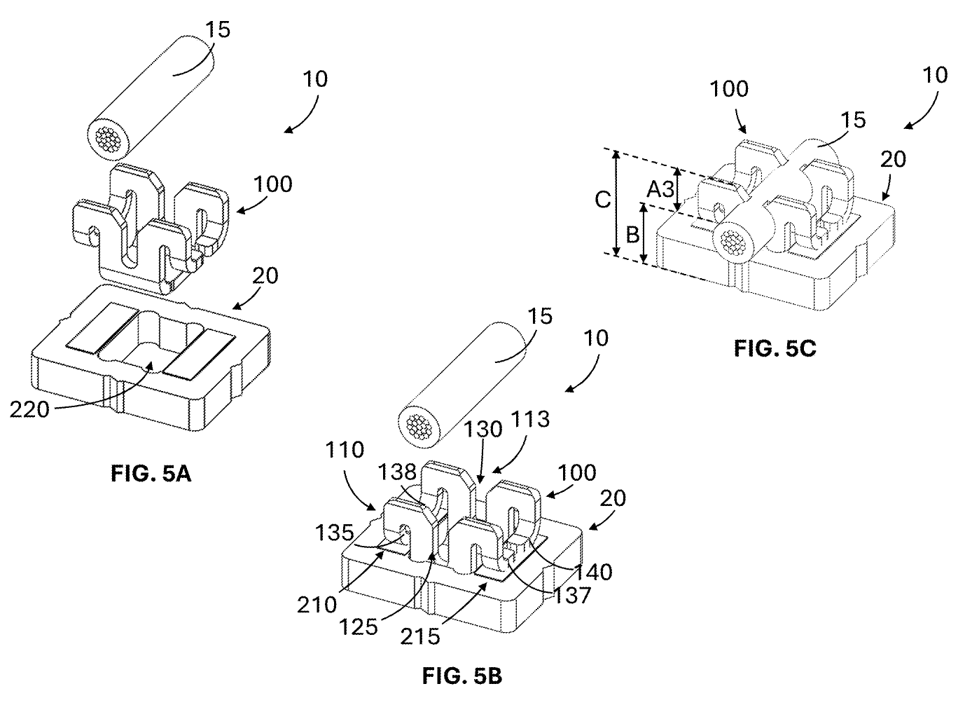

FIGS. 5A-5C show perspective views of the wire connector system 10 in various states of assembly. As illustrated in FIG. 5A, which illustrates an exploded perspective view of the wire connector system 10 in a disassembled state, prior to forming any electrical connection, each component within the wire connector system 10 can be axially aligned. In such an arrangement, the wire 15 can be aligned with each of the first slot 125 and the second slot 130 of the connector 100. The connector 100 itself can be arranged above the aperture 220 of the electrical component 20.

As shown in FIG. 5B, which illustrates a perspective view of the wire connector system 10 in a partially assembled state, prior to insertion of the wire 15, the connector 100 can be coupled to the electrical component 20. When coupled to the electrical component 20, the base portion 105 of the connector 100 can be received within the aperture 220. In various embodiments, the configuration of the base portion 105 relative to the first portion 110 and second portion 113 facilitate placement of the connector 100 within the electrical component 20. For example, the base portion 105 can be inserted into the recess 220 of the electrical component 20 and a vertical position of the connector 100 within the electrical component 20 can be limited based on the vertical offset between a bottom of the base portion and each of the contact pads 150, 152, 155, 157. Accordingly, when connector 100 is placed within the recess 220, the base portion 105 extends a distance A2 into the electrical component 20 and only a portion of the connector 100 having a height A3 extends above the electrical component 20.

Once the base portion 105 is arranged within the aperture 220, each of the contact members 135, 137, 138, and 140 can be positioned above the first conductive pad 210 and the second conductive pad 215. Accordingly, the first contact pad 150 of the first contact member 135 and the second contact pad 152 of the second contact member 137 can be aligned with the respective first conductive pad 210 and the second conductive pad 215. As shown, the contact members 135 and 138 can be positioned over the first conductive pad 210 and the contact members 137 and 140 can be positioned over the second conductive pad 215. Accordingly, the first contact pad 155 of the first contact member 138 and the second contact pad 155 of the second contact member 140 can be aligned with the respective first conductive pad 210 and the second conductive pad 215. In various embodiments, the first contact pads 150, 155 and the second contact pads 152, 157 can be coupled to the respective first and second conductive pads 210, 215. In some embodiments, the first contact pads 150, 155 and the second contact pads 152, 157 can be coupled to the respective first and second conductive pads 210, 215 via soldering.

FIG. 5C shows the wire connector system 10 in a fully assembled state. As shown, when the wire connector system 10 is in the fully assembled state, the first contact pads 150, 155 and the second contact pads 152, 157 can be coupled to the respective first and second conductive pads 210, 215, thereby securing the connector 100 within the electrical component. In addition, as shown, the wire 15 is inserted into each of the first slot 125 and the second slot 130 such that the wire 15 extends between the first portion 110 and the second portion 113 of the connector 100. In various embodiments, when the wire 15 is inserted into each of the slots 125, 130, interior edges of each slot cut through insulation on the wire 15 to facilitate an electrical connection therewith. As shown in FIG. 5C, when the wire connector system 10 is in the fully assembled state, it can have a combined height, C. Because the connector 100 is structured to couple to the electrical component 20 in an overlapping manner, the height C of the wire connector system 10 is less than the sum of the connector height, A1, and the electrical component height, B. More specifically, because the connector 100 is structured to engage with the electrical component 20 in an overlapping manner, the overall height C of the electrical component 20 and the connector 100 is only a sum of the electrical component height B and the height A3, which corresponds to a height of the portion of the connector 100 extending above the electrical component 20 (i.e., when the connector 100 is received within the recess 220). The low-profile arrangement of the wire connector system 10 has significant advantages in that it reduces an amount of space for accommodating a connector and electrical component as the wire connector system 10 requires less vertical space/volume as compared to a non-overlapping arrangement.

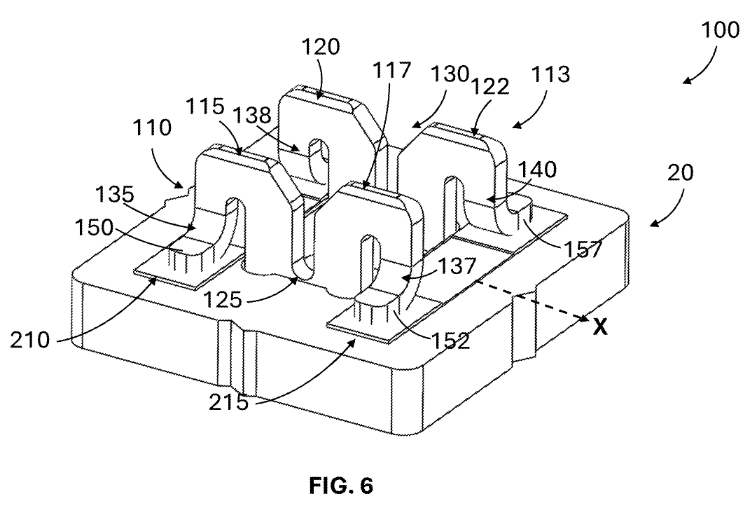

In various embodiments, each of the contact members 135, 137, 138, and 140 (i.e., each of the first contact pads 150, 155 and second contact pads 152, 157) can be structured to bend away from a central axis (e.g., axis X) of the connector 100. For example, as shown in FIG. 6, each of the first contact member 135 and the second contact member 136 of the first portion 110 can be structured to bend away from a central axis of the connector, in a direction away from the second portion 113. Similarly, each of the first contact member 138 and the second contact member 140 of the second portion 113 can be structured to bend away from a central axis of the connector 100, in a direction away from the first portion 110. In such embodiments, each of the first conductive pad 210 and the second conductive pad 215 can be structured to include two conductive regions. As shown, the first conductive pad 210 can include a first conductive region corresponding to the first contact pad 150 of the first contact member 135 and a second conductive region spaced from the first conductive region corresponding to the second contact pad 152 of the first contact member 138. Similarly, the second conductive pad 215 can include a first conductive region corresponding to the first contact pad 155 of the second contact member 137 and a second conductive region corresponding to the second contact pad 157 of the second contact member 140.

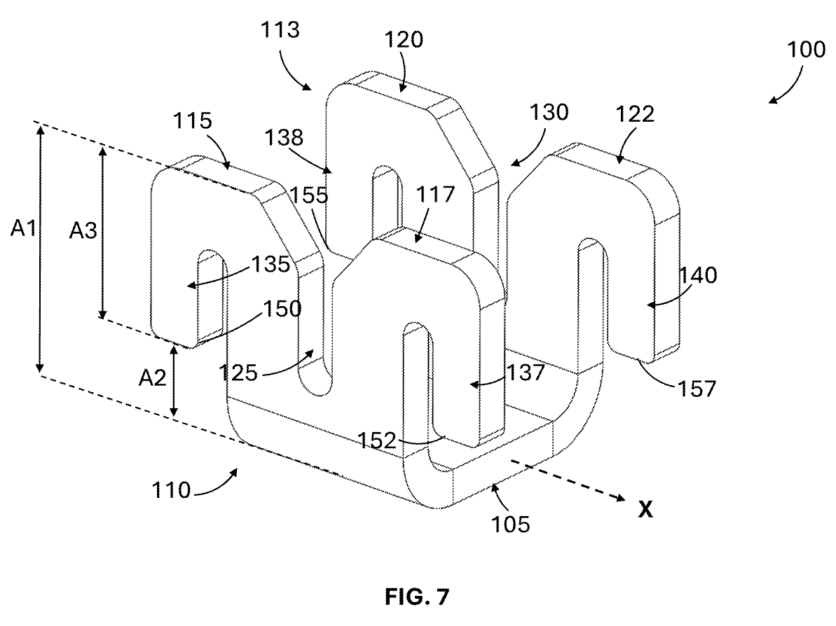

In some embodiments, the connector 100 can be formed without the elbows 160, 162, 165, and 167, such as shown in FIG. 7. As illustrated in FIG. 7, the connector 100 can be formed such that the first contact member 135 and second contact member 137 extend away from the respective first arch 115 and second arch 177 of the first portion 110 such that the first contact member 135 and second contact member 137 are substantially parallel to the first slot 125. Accordingly, as shown, the contact members 135 and 137 do not bend and rather extend downward such that the terminal ends of each of the contact members 135 and 137 form the respective contact pads 150 and 152. As shown, in such embodiments, the contact members 135 and 137 can be structured such that the terminal ends of each of the contact members 135 and 137 form the respective contact pads 150 and 152 at a length A3, as defined from a top of the arches 115 and 117, such that the contact pads 150 and 152 are disposed at a distance A2 from a bottom portion of the base portion 105.

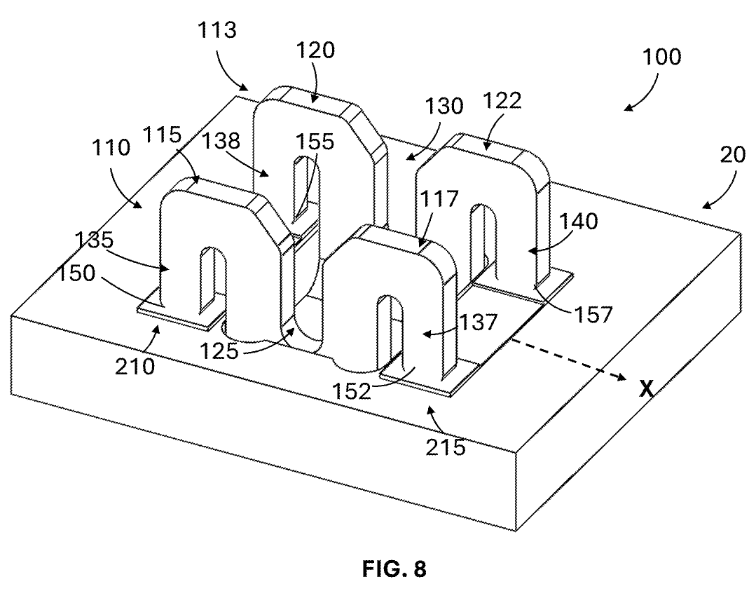

Similarly, the first contact member 138 and second contact member 140 extend away from the respective first arch 120 and second arch 122 of the second portion 113 such that the first contact member 138 and second contact member 140 are substantially parallel to the second slot 130. Accordingly, as shown, the contact members 138 and 140 do not bend and rather extend downward such that the terminal ends of each of the contact members 138 and 140 form the respective contact pads 155 and 157. As shown, in such embodiments, the contact members 138 and 140 can be structured such that the terminal ends of each of the contact members 138 and 140 form the respective contact pads 155 and 157 at a length A3, as defined from a top of the arches 120 and 122, such that the contact pads 155 and 157 are disposed at a distance A2 from a bottom portion of the base portion 105. Accordingly, as shown in FIG. 8, when the base portion 105 of the connector 100 is disposed within the aperture 220 of the electrical component 20, the contact pads 150 and 155 are structured to couple to the first conductive pad 210 and the contact pads 152 and 157 are structured to couple to the second conductive pad 215.

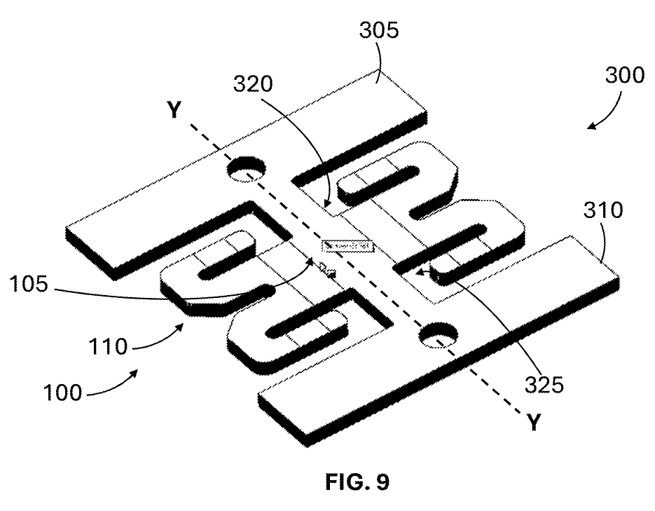

In various embodiments, the connector 100 can be formed from a sheet material segment 300, such as shown in FIG. 9. In some embodiments, the segment 300 can be cut, stamped, or otherwise formed from a sheet of material. The segment 300 can include a first end 305 and a second end 310, which are connected to a region of the segment 300 from which the base portion 105 of the connector 100 can be formed. To form the connector 100, the first portion 110 and the second portion 113 can be folded or bent relative to a longitudinal axis Y-Y of the segment 300. Each of the contact members 135, 137, 138, and 140 can then be bent toward or away from a central axis (e.g., axis X) of the connector 100. The base portion 105 of the connector 100 can then be separated from the segment 300 by severing (e.g., cutting, breaking, snapping, etc.) the first end 305 and second end 310 from the connector 100 on a respective first side 320 and second side 325 of the base portion 105. In various embodiments, the base portion 105 can be separated from the segment 300 prior to bending the first portion 110 and the second portion 113.

Notwithstanding the embodiments described above in reference to FIGS. 1-9, various modifications and inclusions to those embodiments are contemplated and considered within the scope of the present disclosure.

As utilized herein with respect to numerical ranges, the terms “approximately,” “about,” “substantially,” and similar terms generally mean +/- 10% of the disclosed values, unless specified otherwise. As utilized herein with respect to structural features (e.g., to describe shape, size, orientation, direction, relative position, etc.), the terms “approximately,” “about,” “substantially,” and similar terms are meant to cover minor variations in structure that may result from, for example, the manufacturing or assembly process and are intended to have a broad meaning in harmony with the common and accepted usage by those of ordinary skill in the art to which the subject matter of this disclosure pertains. Accordingly, these terms should be interpreted as indicating that insubstantial or inconsequential modifications or alterations of the subject matter described and claimed are considered to be within the scope of the disclosure as recited in the appended claims.

It should be noted that the term “exemplary” and variations thereof, as used herein to describe various embodiments, are intended to indicate that such embodiments are possible examples, representations, or illustrations of possible embodiments (and such terms are not intended to connote that such embodiments are necessarily extraordinary or superlative examples).

The term “coupled” and variations thereof, as used herein, means the joining of two members directly or indirectly to one another. Such joining may be stationary (e.g., permanent or fixed) or moveable (e.g., removable or releasable). Such joining may be achieved with the two members coupled directly to each other, with the two members coupled to each other using a separate intervening member and any additional intermediate members coupled with one another, or with the two members coupled to each other using an intervening member that is integrally formed as a single unitary body with one of the two members. If “coupled” or variations thereof are modified by an additional term (e.g., directly coupled), the generic definition of “coupled” provided above is modified by the plain language meaning of the additional term (e.g., “directly coupled” means the joining of two members without any separate intervening member), resulting in a narrower definition than the generic definition of “coupled” provided above. Such coupling may be mechanical, electrical, or fluidic.

References herein to the positions of elements (e.g., “top,” “bottom,” “above,” “below”) are merely used to describe the orientation of various elements in the FIGURES. It should be noted that the orientation of various elements may differ according to other exemplary embodiments, and that such variations are intended to be encompassed by the present disclosure.

Although the figures and description may illustrate a specific order of method steps, the order of such steps may differ from what is depicted and described, unless specified differently above. Also, two or more steps may be performed concurrently or with partial concurrence, unless specified differently above.

It is important to note that any element disclosed in one embodiment may be incorporated or utilized with any other embodiment disclosed herein. Although only one example of an element from one embodiment that can be incorporated or utilized in another embodiment has been described above, it should be appreciated that other elements of the various embodiments may be incorporated or utilized with any of the other embodiments disclosed herein.

What is claimed is:

1. A wire connector comprising:
a base portion;
a first portion extending from a first side of the base portion; and
a second portion extending from a second side of the base portion, the second side being opposite the first side;
wherein each of the first portion and the second portion are bent relative to the base portion toward a central axis of the connector; and
wherein each of the first portion and the second portion includes:
a first contact member and a second contact member, each of the first contact member and second contact member structured to bend toward the central axis of the connector.

2. The wire connector of claim 1, wherein the first contact member and the second contact member are structured to bend at an angle of approximately 90 degrees.

3. The wire connector of claim 1, wherein the first portion forms a first slot and the second portion forms a second slot, the second slot being aligned with the first slot.

4. The wire connector of claim 3, wherein at least one interior edge of each of the first slot and the second slot is sharpened.

5. The wire connector of claim 3, wherein a length of the first slot and the second slot is equivalent to a distance between a top edge of the wire connector and a bottom edge of each of the first contact member and second contact member.

6. The wire connector of claim 3, wherein each of the first portion and the second portion further comprises a first arch and a second arch; and
wherein the first slot is formed between the first arch and second arch of the first portion, and the second slot is formed between the first arch and second arch of the second portion.

7. The wire connector of claim 6, wherein the first contact member and second contact member are formed at the terminal ends of the first arch and the second arch, respectively.

8. The wire connector of claim 1, wherein each of the first contact member and the second contact member comprises a contact pad at a terminal end thereof, wherein the contact pad is disposed at a distance above the base portion.

9. A wire connector assembly comprising:
an electrical component having a first height, the electrical component comprising:
a first conductive region;
a second conductive region; and
an aperture disposed between the first conductive region and the second conductive region;
a wire connector having a second height and being structured to couple to the electrical component, the wire connector comprising:
a base portion;
a first portion extending from a first side of the base portion; and
a second portion extending from a second, opposite side of the base portion;
wherein the base portion of the wire connector is structured to be received within the aperture of the electrical component such that a third height of the wire connector assembly is less than a sum of the first height and the second height.

10. The wire connector assembly of claim 9, wherein each of the first portion and the second portion comprises:
a first arch;
a second arch; and
a slot formed between the first arch and the second arch.

11. The wire connector assembly of claim 10, further comprising a wire, wherein the wire is configured to be received within the slot of each of the first portion and the second portion.

12. The wire connector assembly of claim 11, wherein at least one interior edge of the slot is sharpened such that when the wire is received within the slot of each of the first portion and the second portion, the at least one interior edge of the slot cuts through insulation surrounding the wire.

13. The wire connector assembly of claim 10, where the first arch terminates in a first contact member and the second arch terminates in a second contact member, the first contact member structured to bend away from the first arch and the second contact member structured to bend away from the second arch.

14. The wire connector assembly of claim 13, wherein the first contact member and second contact member are structured to bend toward a central axis of the wire connector.

15. The wire connector assembly of claim 13, wherein the first contact member and second contact member are structured to bend away from a central axis of the wire connector.

16. The wire connector assembly of claim 13, wherein the first contact member of the first portion and the first contact member of the second portion are structured to couple to the first conductive region, and the second contact member of the first portion and the second contact member of the second portion are structured to couple to the second conductive region.

17. The wire connector assembly of claim 9, wherein the electrical component is a printed circuit board.

18. A method of forming a wire connector assembly, the method comprising:
forming a wire connector;
coupling the wire connector to an electrical component; and
connecting a wire to the wire connector;
wherein the wire connector comprises:
a base portion;
a first portion extending from a first side of the base portion; and
and a second portion extending from a second, opposite side of the base portion; and
wherein the electrical component comprises:
an aperture;
a first conductive region disposed on a first side of the aperture; and
a second conductive region disposed on a second side of the aperture; and
wherein coupling the wire connector to the electrical component comprises:
inserting the base portion into the aperture;
coupling a first region of each of the first portion and the second portion to first conductive region; and
coupling a second region of each of the first portion and the second portion to the second conductive region.

19. The method of claim 18, wherein coupling the first region of each of the first portion and the second portion to the first conductive region comprises soldering the first region of each of the first portion and the second portion to the first conductive region; and
wherein coupling the second region of each of the first portion and the second portion to the second conductive region comprises soldering the second region of each of the first portion and the second portion to the second conductive region.

20. The method of claim 18, wherein forming the wire connector comprises:
forming a sheet material segment;
forming each of the first portion and the second portion by bending the first portion and the second portion relative to a central axis of the sheet material segment; and
separating the wire connector from the sheet material segment by separating the base portion at a first side and a second side.
